(19) United States
(12) Patent Application Publication
(10) Pub. No.: US 2024/0396239 A1
(43) Pub. Date: Nov. 28, 2024

(54) Connection Device

(71) Applicant: GITech, Inc., Austin, TX (US)

(72) Inventor: John Williams, Austin, TX (US)

(21) Appl. No.: 18/634,925

(22) Filed: Apr. 13, 2024

(30) Foreign Application Priority Data
May 24, 2023 (TW) 112119351

(51) Int. Cl. H01R 12/70; H01R 12/53; H01R 12/71; H01R 13/6591

(52) U.S. Cl. CPC H01R 12/7082; H01R 12/7047; H01R 12/714; H01R 13/65914; H01R 12/53

(57) ABSTRACT

A connection device provides electrical connection between a shielded electrical cable and a host device, such as a host printed circuit board. The connection device includes an integrated unit with a printed circuit module provided to receive the shielded electrical cable and provide connection to the signal wire and the outer shield of the cable. The connection device further includes a conducting unit with a conducting module to connect the printed circuit module to the host device.

### CROSS REFERENCE TO RELATED APPLICATIONS

This application claims the benefit of Patent Application No. TW112119351 filed in Taiwan, Republic of China on May 24, 2023.

### FIELD OF THE INVENTION

The invention relates to an electrical connector and, in particular, to an electrical connection device for connecting a shielded electrical cable to a host device, such as a host printed circuit board.

### BACKGROUND OF THE INVENTION

Coaxial cables are a type of shielded electrical cable used to carry high-frequency electrical signals with low losses and minimal electromagnetic interference. Coaxial cables are used in such applications as telephone and radio transmission lines, telephone trunk lines, broadband internet networking cables, high-speed computer data busses, cable television transmission lines, and connecting radio transmitters and receivers to their antennas. Coaxial cables have defined dimensions for coupling with connectors to give a precise, constant conductor spacing, which is needed to function efficiently as a transmission line.

Coaxial cables and associated terminal devices are mostly connected using coaxial connectors, being a circular plug with specific dimensions. In some applications, connection of a coaxial cable to a printed circuit board is desired. Printed circuit boards are widely used as the main circuit of an electronic device, thereby increasing the demand for providing a connection between a coaxial cable and a printed circuit board. However, the circular shape of the conventional coaxial connector is burdensome to integrate with a printed circuit board due to the large size of the connector. Accordingly, the conventional circular coaxial connector is not the ideal choice for mounting a coaxial cable onto a printed circuit board.

### SUMMARY OF THE INVENTION

The present disclosure discloses a connection device, substantially as shown in and/or described below, for example in connection with at least one of the figures, as set forth more completely in the claims.

In some embodiments, a connection device for connecting to an electrical component includes an integrated unit, a shielded electrical cable and a conducting unit. In one embodiment, the integrated unit includes a package housing defining an installation space within the package housing, the package housing including a first opening provided on a first surface and a passage providing a second opening on a second surface orthogonal to the first surface, the passage connecting the second opening to the installation space. The integrated unit further includes a printed circuit module disposed in the installation space and having a set of first connecting elements provided in the installation space and a set of second connecting elements provided on the first surface of the package housing, each of the first connecting elements being electrically connected to a respective one of the second connecting elements. The shielded electrical cable is disposed in the passage of the package housing and having one or more signal wires connecting to respective first connecting elements. The conducting unit includes a housing defining an installation slot and a conducting module disposed in the installation slot, the conducting module including conductive elements formed therein and extending from a first surface of the housing to connect to the second connecting elements of the integrated unit and extending from a second surface of the housing, opposite the first surface, to be connected to the electrical component.

These and other advantages, aspects and novel features of the present invention, as well as details of an illustrated embodiment thereof, will be more fully understood from the following description and drawings.

### BRIEF DESCRIPTION OF THE DRAWINGS

Various embodiments of the invention are disclosed in the following detailed description and the accompanying drawings. Although the drawings depict various examples of the invention, the invention is not limited by the depicted examples. It is to be understood that, in the drawings, like reference numerals designate like structural elements. Also, it is understood that the depictions in the figures are not necessarily to scale.

FIG. 1 is an exploded perspective view of the connection device in a first embodiment.

FIG. 2 is a cross-sectional view of the connection device of FIG. 1 through a longitudinal axis of the connection device in some embodiments.

FIGS. 3A and 3B are perspective views of the connection device illustrating the printed circuit module of the integrated unit and the conducting module, with and without connection to a host device, in some embodiments.

FIGS. 4A and 4B are cross-sectional front views of the connection device illustrating the connection of the twinaxial cables and the printed circuit module in some embodiments.

FIGS. 5A and 5B are perspective views of the connection device as viewed from the conducting unit, with and without the host device, in embodiments of the present invention.

FIG. 6 is a cross-sectional view of a connection device through a longitudinal axis of the connection device in a second embodiment.

FIGS. 7 and 8 are cross-sectional views illustrating the connection device of FIG. 6 in some embodiments.

### DETAILED DESCRIPTION OF THE INVENTION

In embodiments of the present invention, a connection device provides electrical connection between a shielded electrical cable and a host device, such as a host printed circuit board, sometimes referred to as a “mother board”. The connection device includes an integrated unit with a printed circuit module provided to receive the shielded electrical cable and provide connection to the signal wire and the outer shield of the cable. The connection device further includes a conducting unit with a conducting module to connect the printed circuit module to the host device.

In the present description, a “shielded electrical cable” refers an electrical cable with one or more inner conductors surrounded by, and insulated from, an outer conducting shield. In one example, the shielded electrical cable is a coaxial cable which includes a single inner conductor surrounded by a concentric conducting shield, with the two separated by a dielectric or insulating material. The outer conducting shield wraps around the inner conductor and is usually electrically grounded. With the configuration of the outer conductive shield wrapping around the inner conductor, the quality of the signals transmitted by the inner conductor can be optimized by shielding effect. In another example, the shielded electrical cable is a twinaxial cable, which is a variation of the coaxial cable. The twinaxial cable (or twinax) includes two inner connectors, typically in a twisted pair, surrounded by and insulated from an outer conducting shield, which is usually electrically grounded. Twinaxial cables are sometimes applied in short-range high-speed differential signaling applications.

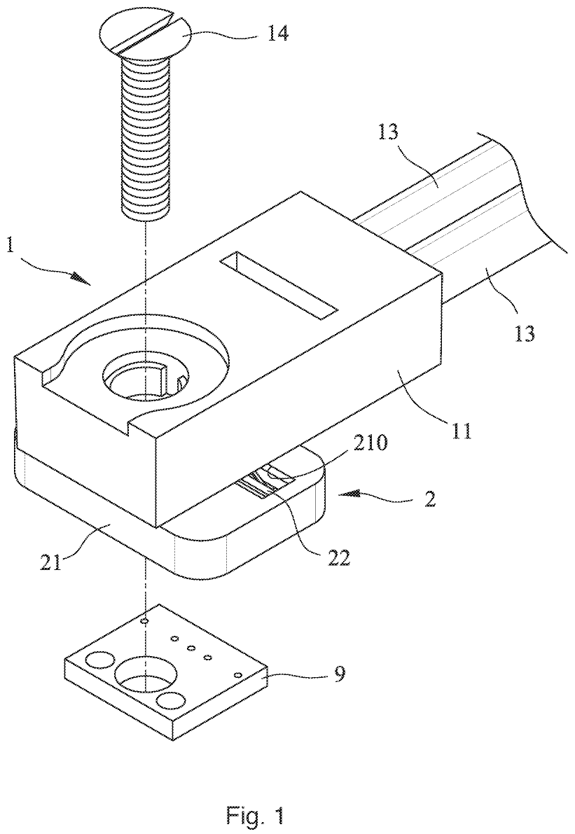

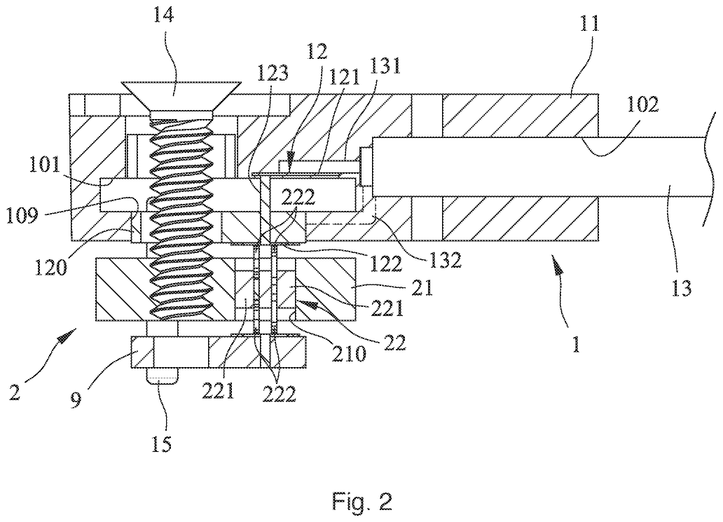

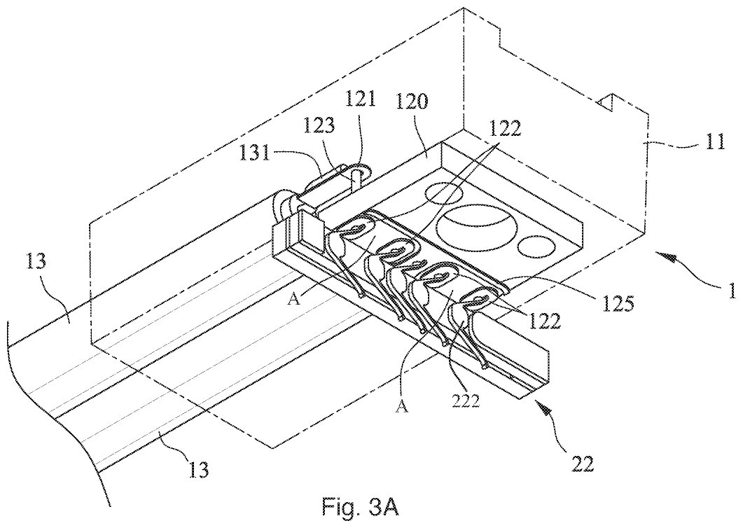

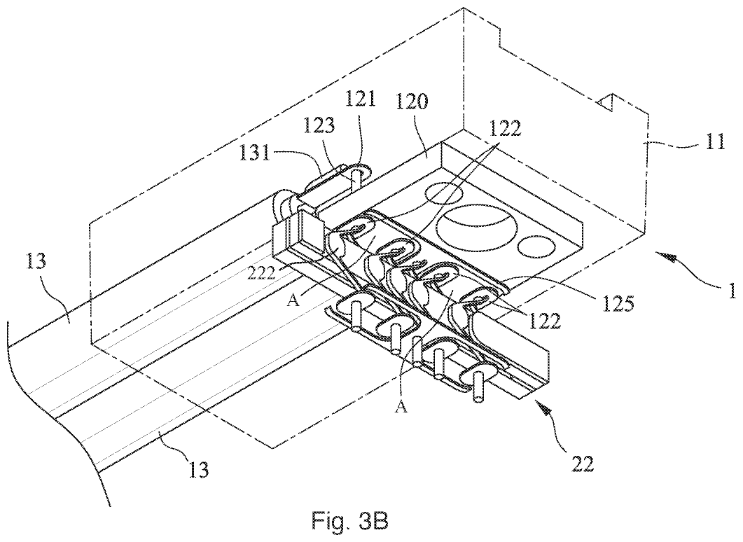

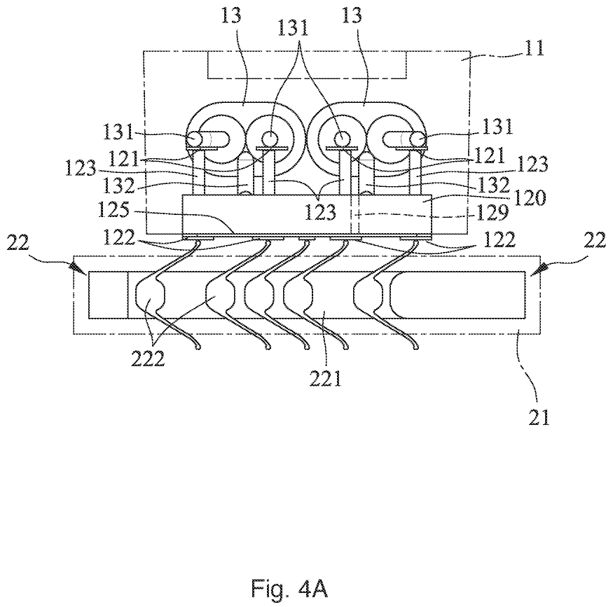

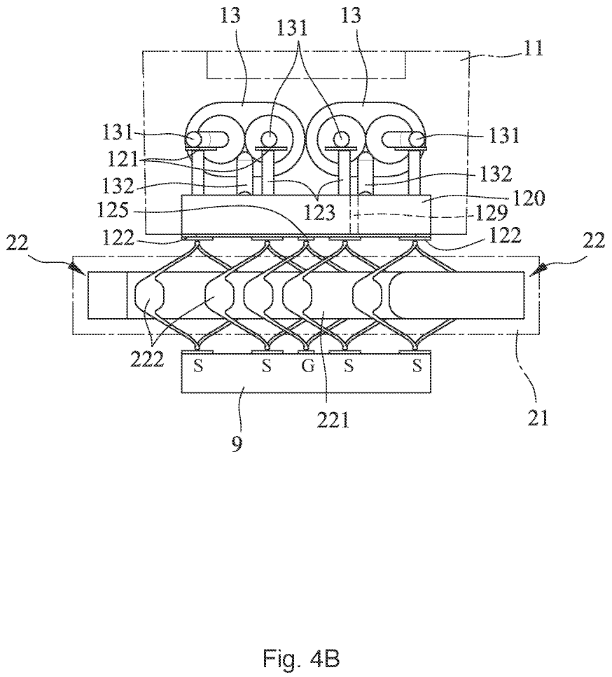

The connection device in a first embodiment of the present invention will be described with reference to FIGS. 1-4B. FIG. 1 is an exploded perspective view of the connection device in a first embodiment. FIG. 2 is a cross-sectional view of the connection device of FIG. 1 through a longitudinal axis of the connection device in some embodiments. FIGS. 3A and 3B are perspective views of the connection device illustrating the printed circuit module of the integrated unit and the conducting module, with and without connection to a host device, in some embodiments. FIGS. 4A and 4B are cross-sectional front views of the connection device illustrating the connection of the twinaxial cables and the printed circuit module in some embodiments.

Referring to FIGS. 1-4B, the connection device includes an integrated unit 1 and a conducting unit 2 coupled and connecting to the integrated unit 1. The integrated unit 1 includes a package housing 11 which defines an installation space 101 with an opening 109 on a first surface and a passage 102 providing a second opening on a second surface. The first surface and the second surface are orthogonal to each other. The passage 102 connects the second opening to the installation space 101. The integrated unit 1 further includes a printed circuit module 12 provided in the installation space 101 and having one or more first connecting elements 121 provided in the installation space 101 and multiple second connecting elements 122 provided on the first surface of the package housing. The printed circuit module 12 is provided to connect each of the first connecting elements 121 to a respective second connecting element 122.

The integrated unit 1 includes the passage 102 for receiving a shielded electrical cable 13 for connection to the printed circuit module 12. In one embodiment, the integrated unit 1 includes a single passage 102 to receive a single shielded electrical cable, such as a single coaxial cable or a single twinaxial cable. A coaxial cable includes a single inner conductor and an outer shield and therefore is associated with one signal wire and one ground wire (connected to the outer shield). A twinaxial cable includes two inner conductors and an outer shield and therefore is associated with two signal wires and one ground wire. In the present description, the integrated unit 1 is illustrated as receiving two twinaxial cable, for a total of four signal wires and two ground wires (connected to the outer shield). The embodiments shown in the present description is illustrative only and not intended to be limiting. The connection device of the present invention can be configured for use with any suitable combination of shielded electrical cables, including one or more coaxial cables, one or more twinaxial cables, or a combination of coaxial and twinaxial cables.

Referring still to FIGS. 1-3, in the present embodiment, the passage 102 includes one passage or a pair of passages for receiving a pair of twinaxial cables 13. The twinaxial cables 13 are then connected to the printed circuit module 12. For example, the inner conductors of each twinaxial cable 13 are connected to respective first connecting elements 121 of the printed circuit module 12. A ground wire 132 connects the output shield of the twinaxial cable 13 to a grounding structure 125 (FIGS. 3A and 3B) of the printed circuit module 12. The printed circuit module 12 includes conductive vias and/or traces to connect the first connecting elements 121 to the second connecting elements 122 provided on the first surface. As shown in FIG. 3A, the grounding structure 125 is provided at the first surface of the printed circuit module to function as a ground plane.

In the present embodiment, the integrated unit 1 includes a fastening hardware 14, such as a screw, to affix the printed circuit module 12 to the package housing 11 and further to affix the integrated unit 1 to the conducting unit 2. The connection device may further include one or more alignment pins 15 (FIGS. 1 and 2) used to align the conducting unit 2 to a host device 9 to be connected. In one example, two alignment pins 15 are provided and positioned on two sides of the fastening hardware 14. In FIGS. 1 and FIGS. 3A and 3B, the alignment pins are not shown for simplicity but the positions of the alignment pins are denoted by the smaller circles provided next to the big circle in which the fastening hardware is positioned. In the present embodiment, alignment pins 15 are used to facilitate alignment of the conducting unit to the host device 9 to be connected. In other embodiments, other method or mechanism for providing alignment can be used. The use of alignment pins 15 in the present embodiment is illustrative only and not intended to be limiting.

In one embodiment, the package housing 11 is configured to accommodate the printed circuit module 12 and the shielded electrical cables 13. In the installation space, the outer insulation covering on the ends of each twinaxial cable 13 may be removed to expose the inner conductor (the signal wire). The exposed end of the twinaxial cable 13 is inserted into the package housing 11 through the passage 102. In some embodiments, the insertion distance is at least preferably at least 3.7 mm. As thus configured, the shielded electrical cable can be secured to the printed circuit module 12 inside the package housing 11.

Referring now to FIGS. 2, 3A and 3B, the printed circuit module 12 has an insulated substrate 120 with the first connecting elements 121 provided facing the passage 102 and the second connecting elements 122 provided on the first surface (i.e. the surface of the opening 109). In the present embodiment, there are four first connecting elements 121 and four second connecting elements 122 to connect to the pair of twinaxial cables 13. In the present embodiment, the printed circuit module 12 further includes third connecting elements 123 provided to electrically connect the first connecting elements 121 to the second connecting elements 122. In some embodiments, the third connecting elements 123 are vias formed in the printed circuit module 12. In particular, each third connecting element 123 (a via) connects a first connecting element 121 to a second connecting element 122.

In the present embodiment, the printed circuit module 12 further includes the grounding structure 125 (FIGS. 3A, 3B) formed on the insulated substrate 120 on the first surface of the package housing 11. In some embodiments, the grounding structure 125 is in the form of a conductive plate. In one embodiment, the grounding structure 125 is formed directly on the insulated substrate 120 by using a printing process. As shown in FIG. 3A, the grounding structure 125 is shaped to define two isolated areas “A” which are electrically insulated from each other. As thus configured, in each isolated area A, two second connecting elements 122 are positioned. Accordingly, the two pairs of second connecting elements 122 are insulated from each other and the ground structure 125 provides a shielding effect on a plane parallel to the insulated substrate 120.

Referring now to FIGS. 3A, 3B, 4A and 4B, as described above, in the present embodiment, the shielded electrical cables 13 are twinaxial cables. Each of the twinaxial cables 13 includes two inner conductors as two signal wires 131 and an outer shield connected to the ground wire 132. The ground wire 132 is electrically connected to the grounding structure 125. The signal wires 131 are connected to the first connecting elements 121 respectively, so that the signals are to be transmitted from the first connecting elements 121 to the third connecting elements 123 and onto the second connecting elements 122. Meanwhile, the ground wire 132 is connected to the grounding structure 125 to provide grounding effect for the integrated unit 1 and the shielded electrical cables 13. In the present embodiment, as shown in FIGS. 4A and 4B, the grounding structure 125 includes an extension portion 129 extending through the insulated substrate 120 to connect the ground wire 132 to the grounding structure 125. In this manner, the ground wire 132 can be biased to the same ground potential as the grounding structure 125.

Referring now to FIGS. 2, 3A and 4A, the conducting unit 2 includes a housing 21 which surrounds and defines an installation slot 210 and a conducting module 22 disposed in the installation slot 210 for connection to the second connecting elements 122 of the integrated unit 1. The conducting module includes conductive elements 222 extending from a first surface of the housing 21 to connect to the second connecting elements 122 of the integrated unit 1 and extending from a second surface of the housing 21 to be connected to the host device 9, the second surface being opposite the first surface. The host device 9 can be an electrical component, such as a printed circuit board. In some examples, the host device 9 is a printed circuit board that is used as a mother board of a computing device. FIGS. 3A and 4A illustrate the connection device without the host device. FIGS. 3B and 4B illustrate the connection device with the host device connected thereto.

In some embodiments, the conductive elements 222 are compliant spring contact elements having a first end and a second end. The first end of each conductive element 222 extends from the first surface of the housing 21 to connect to a respective second connecting element 122 of the integrated unit 1. The second end of each conductive element 222 extends from the second surface of the housing 21 to connect to a connection point of the host device 9, such as a conductive landing pad. In the present example, four conductive elements 222 are provided to connect to the second connecting elements 122 carrying signals from the four signal wires 131. The conducting unit 2 includes at least one additional conductive element 222 provided to connect to the grounding structure 125 to function as a ground pin. In the present example, when the host device 9 is coupled to connection device in the manner as described above, four conductive elements 222, labeled “S” in FIG. 4B, carry the signals from the signal wires 131 to landing pads of the host device 9 and one conductive element 222, labeled “G” in FIG. 4B, connects the ground structure 125 to a landing pad of the host device 9.

In the present embodiment, the conducting module 22 includes the conductive elements 222 formed on one or more insulated plates 221. The conductive elements 222 are arranged spaced apart on the insulated plates 221 and positioned in alignment with the second connecting elements 122 and the grounding structure 125. In the embodiment shown in FIGS. 2, 3B and 4B, two sets of conductive elements 222 are shown, each set being isolated by each other by one or more insulated plates 221. The two sets of conductive elements 222 are connected in parallel. That is, a pair of conductive elements 222, one from each set, contact a respective second connecting elements 122 or the grounding structure 125. In this manner, redundancy is provided with each second connecting element 122 (or the grounding structure 125) being connected to two conductive elements 222. The use of a pair of conductive elements 222 for each connection is illustrative only and not intended to be limiting. In other embodiments, as shown in FIGS. 3A and 4A, the conducting unit 2 may provide only one conductive element 222 for each second connecting element 122 or the grounding structure 125. In the case the conducting module 22 includes two or more sets of conductive elements 222, each set of conductive elements is isolated from an adjacent set by an insulated plate 221. That is, insulated plates 221 and conductive elements 222 may be alternately provided to form the conducting module 22.

In some embodiments, the conductive elements 222 are manufactured using a single-plate-through semiconductor process. Patterning of a conductive plate is made to form conductive elements in alignment with the positions of the second conducting elements 122 and the grounding structure 125. In one embodiment, the conductive elements 222 are formed of copper or a copper alloy, such as, for example, beryllium copper. In other embodiments, the conductive elements 222 can be formed from spring steel or another conductive metal or metal alloy.

As thus configured, the fastening hardware 14 penetrates through the package housing 11 and the printed circuit module 12, so as to fix the printed circuit module 12 to the conducting unit 2. Meanwhile, the one or more alignment pins 15 penetrate through the package housing 11, the printed circuit module 12, and the housing 21 of the conducting unit 2, so as to fix the relative position of the printed circuit module 12 and the conducting module 22. The alignment pins 15 further extend from the housing 21 of the conducting unit 2 to be used to align with the host device 9, as shown in FIG. 2. In this manner, the printed circuit module 12 and the conducting module 22 will be reliably connected to each other to transmit signals in a stable manner.

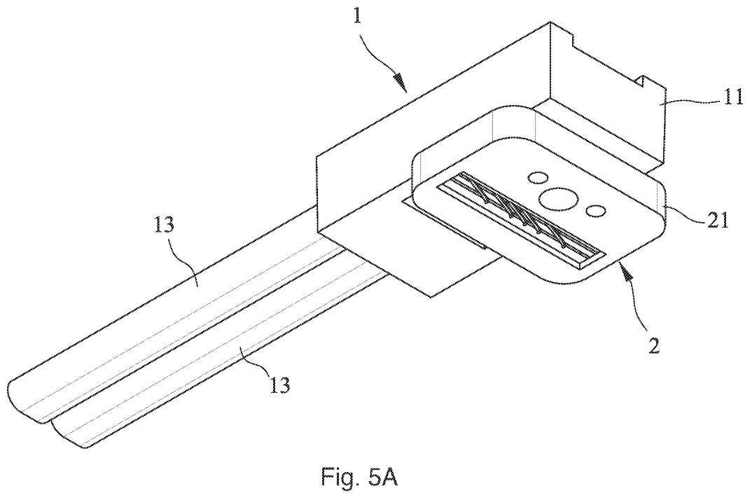

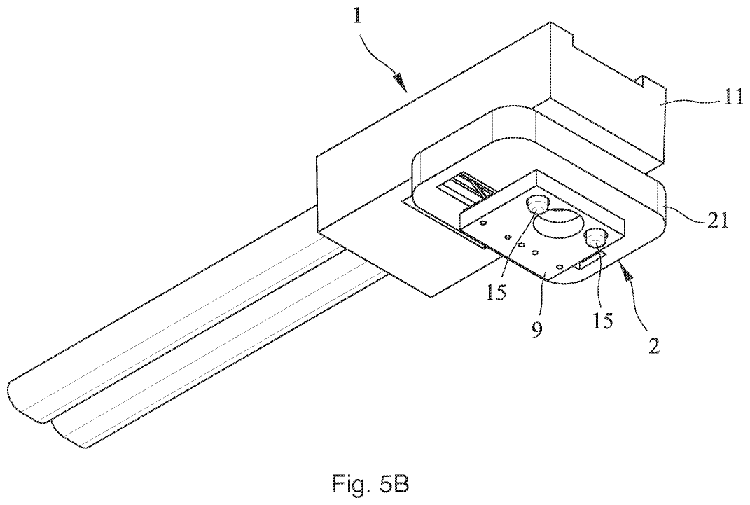

FIGS. 5A and 5B are perspective views of the connection device as viewed from the conducting unit, with and without the host device, in embodiments of the present invention. Referring to FIG. 5A, the connection device with the integrated unit 1 and the conducting unit 2 are assembled with the shielded electrical cables 13 attached there to. Referring to FIG. 5B, the connection device may then be attached to a host device 9 with the alignment pins 15 used to align the host device to the conducting unit 2 so that the conductive elements 222 make contact with the respective conductive pads of the host device 9. In this manner, a connection device that provides effective connection between a shielded electrical cable and a host device is realized.

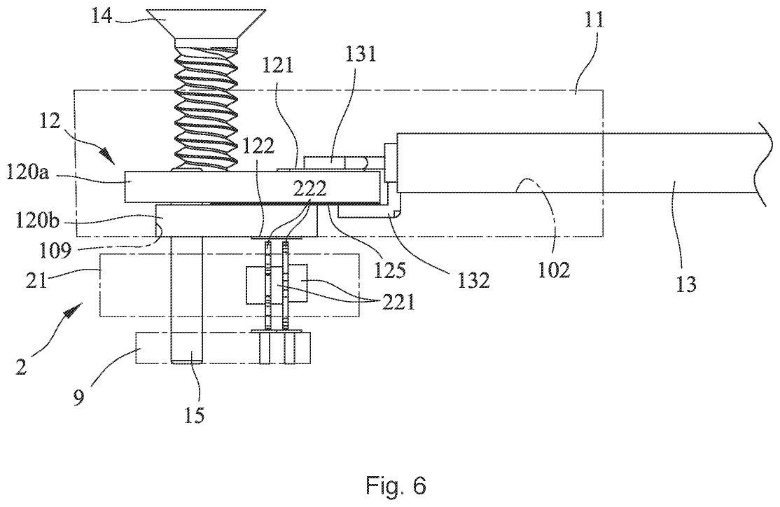

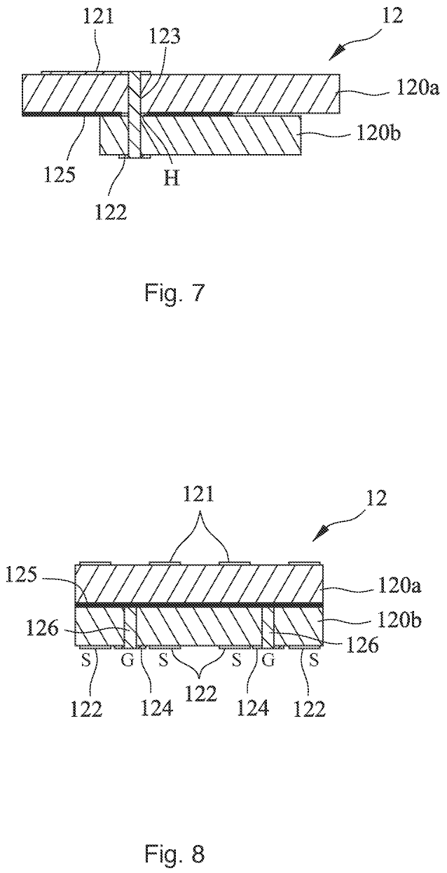

FIG. 6 is a cross-sectional view of a connection device through a longitudinal axis of the connection device in a second embodiment. FIGS. 7 and 8 are cross-sectional views illustrating the connection device of FIG. 6 in some embodiments. Referring to FIGS. 6-8, in the alternate embodiment, the printed circuit module 12a is formed by a first insulated substrate 120a and a second insulated substrate 120b, separated by each other with the grounding structure 125 formed therebetween. The first connecting elements 121 are formed on the first insulated substrate 120a and provided facing the passage 102. The second connecting elements 122 are formed on the second insulated substrate 120b and provided facing the opening 109. The third connecting elements 123 connect the first connecting elements 121 to the second connecting elements 122, respectively.

In the present embodiment, the printed circuit module 12 includes two grounded contacts 124 formed on the second insulated substrate 120b. The two grounded contacts are connected to the grounding structure 125 through conducting elements 126, as shown in the partial cross-sectional view along the longitudinal axes in FIG. 8. The grounded contacts 124 are provided coplanar with (i.e., on the same surface as) the second connecting elements 122 for connection with the conductive elements of the conducting unit 2. In FIG. 8, four second connecting elements 122, labeled “S”, carry the signals from the signal wires 131 and two second connecting element 122, labeled “G”, connect to the ground structure 125 to provide a ground potential.

In the present embodiment, the area of the first insulated substrate 120a and the area of the second insulated substrate 120b can be made different. In particular, the second insulated substrate 120b can be made shorter than the first insulated substrate 120a in the longitudinal axis of the connection device, thereby exposing a portion of the grounding structure 125 formed on the first insulated substrate 120. The exposed portion of the grounding structure 125 is used by the ground wire 132 to make connection thereto, as shown in FIG. 6. That is, the ground wire 132 can be directly connected to the grounding structure 125, at the exposed portions of the grounding structure.

In order to achieve a “shielding effect” of the signals by the grounding structure 125, the grounding structure 125 includes one or more penetrating holes (H) for the third connecting elements 123 to pass through, as shown in the partial cross-sectional view along the longitudinal axes in FIG. 7. In this manner, the signals transmitted on the signal wires to the first and third connecting elements will be shielded by the grounding structure 125. The quality of the signals transmitted from the coaxial cables 13 to the conducting unit 2 is thereby improved.

The connection device in the second embodiment shown in FIGS. 6-8 is constructed in the same manner as the connection device described above in FIGS. 1-5, except for the use of the first and second insulated substrate 120a, 120b and the partial exposure of the grounding structure 125. The remaining elements of the connection device in FIGS. 6-8 that are similar to the connection device in FIGS. 1-5 will not be further described.

The connection device in embodiments of the present invention enables a coaxial or twinaxial cable to be properly and reliably connected to a printed circuit module. The connection device further enables, by the use of a conducting module, reliable connection to a host device. In this manner, reliable and high quality connection of a coaxial or twinaxial cable to a printed circuit board, such as a mother board of a computing device, can be achieved.

In this detailed description, process steps described for one embodiment may be used in a different embodiment, even if the process steps are not expressly described in the different embodiment. When reference is made herein to a method including two or more defined steps, the defined steps can be carried out in any order or simultaneously, except where the context dictates or specific instruction otherwise are provided herein. Further, unless the context dictates or express instructions otherwise are provided, the method can also include one or more other steps carried out before any of the defined steps, between two of the defined steps, or after all the defined steps.

In this detailed description, various embodiments or examples of the present invention may be implemented in numerous ways, including as a process; an apparatus; a system; and a composition of matter. A detailed description of one or more embodiments of the invention is provided above along with accompanying figures that illustrate the principles of the invention. The invention is described in connection with such embodiments, but the invention is not limited to any embodiment. Numerous modifications and variations within the scope of the present invention are possible. The scope of the invention is limited only by the claims and the invention encompasses numerous alternatives, modifications, and equivalents. Numerous specific details are set forth in the description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured. The present invention is defined by the appended claims.

1. A connection device for connecting to an electrical component, comprising:
an integrated unit, comprising:
a package housing defining an installation space within the package housing, the package housing including a first opening provided on a first surface and a passage providing a second opening on a second surface orthogonal to the first surface, the passage connecting the second opening to the installation space;
a printed circuit module disposed in the installation space and having a plurality of first connecting elements provided in the installation space and a plurality of second connecting elements provided on the first surface of the package housing, each of the first connecting elements being electrically connected to a respective one of the second connecting elements;
a shielded electrical cable disposed in the passage of the package housing and having one or more signal wires connecting to respective first connecting elements;
a conducting unit including a housing defining an installation slot and a conducting module disposed in the installation slot, the conducting module comprising conductive elements formed therein and extending from a first surface of the housing to connect to the second connecting elements of the integrated unit and extending from a second surface of the housing, opposite the first surface, to be connected to the electrical component.

2. The connection device of claim 1, wherein the printed circuit module of the integrated unit further comprises a plurality of the third connecting elements, each third connecting element connecting a respective first connecting elements to a respective second connecting element.

3. The connection device of claim 2, wherein the printed circuit module further comprises an insulated substrate disposed at the first surface of the package housing and a grounding structure formed on the insulated substrate at the first surface of the package housing, the second connecting elements being electrically isolated form the grounding structure; and wherein the shielded electrical cable comprises a twinaxial cable having two signal wires connecting to respective first connecting elements and an outer conductive shield connecting to a ground wire which is connected to the grounding structure.

4. The connection device of claim 3, wherein both of the second connecting elements and the grounding structure are formed on a first surface of the insulated substrate being the first surface of the package housing and the first connecting elements is provided in the insulation space on a second surface, opposite the first surface, of the insulated substrate.

5. The connection device of claim 4, wherein the grounding structure defines a plurality of isolated areas in which one or more second connecting element are positioned, the isolated area being electrically isolated from each other.

6. The connection device of claim 2, wherein the printed circuit module further comprises a first insulated plate and a second insulated plate with a grounding structure disposed therebetween, the second insulated plate being disposed at the first surface of the package housing and the first insulated plate being provided on a side of the second insulated plate opposite the first surface of the package housing, the printed circuit modulate further comprising at least one grounded contact formed on the second insulated plate at the first surface of the package housing and at least one conducting element connecting the grounded contact to the grounding structure.

7. The connection device of claim 6, wherein the shielded electrical cable comprises a twinaxial cable having two signal wires connecting to respective first connecting elements and an outer conductive shield connected to a ground wire, the ground wire being connected to the grounding structure.

8. The connection device of claim 6, wherein the grounding structure comprises a plurality of penetrating holes, each third connecting element passing through a respective hole and being insulated from the grounding structure.

9. The connection device of claim 6, wherein the first insulated plate has a first side and a second side, and the second insulated plate has a first side and a second side, the second sides being opposite the first sides, the grounding structure being provided between the first side of the first insulated plate and the second side of the second insulated plate, the first connecting elements being provided on the second side of the first insulated plate and the second connecting elements being provided on the first side of the second insulated plate.

10. The connection device of claim 9, wherein the grounded contact is formed on the first side of the second insulated plate on the first surface of the package housing.

11. The connection device of claim 1, wherein the integrated unit further comprises a fastening hardware penetrating through the package housing, the printed circuit module and the housing of the conducting unit to affix the printed circuit module to the conducting unit.

12. The connection device of claim 11, wherein the integrated unit further comprises an alignment pin penetrating through the package housing, the printed circuit module, and the housing of the conducting unit to align the conductive elements of the conducting module to the second connecting elements.

13. The connection device of claim 1, wherein the conducting module comprises a plurality of insulated plates, the conductive elements being formed between a pair of adjacent insulated plates and being spaced apart from each other along the direction of the insulated plates.

14. The connection device of claim 13, wherein each conductive element comprises compliant spring contact elements having a first end and a second end, the first end extending from the first surface of the housing to connect to the second connecting elements of the integrated unit and the second end extending from the second surface of the housing to be connected to conductive pads of the electrical component.

15. The connection device of claim 1, wherein each second connecting element is electrically connected to a respective conductive pad of the electrical component by a single conductive element of the conductive module.

16. The connection device of claim 1, wherein each second connecting element is electrically connected to a respective conductive pad of the electrical component by a pair of conductive elements of the conductive module.

17. The connection device of claim 16, wherein the conducting module comprises a plurality of insulated plates, the conductive elements being formed between pairs of adjacent insulated plates and being spaced apart from each other along the direction of the insulated plates, wherein each second connecting element is electrically connected to a respective conductive pad of the electrical component by a pair of conductive elements provided on opposite sides of a respective insulated plate.

18. The connection device of claim 17, wherein each conductive element comprises compliant spring contact elements having a first end and a second end, the first end extending from the first surface of the housing to connect to the second connecting elements of the integrated unit and the second end extending from the second surface of the housing to be connected to conductive pads of the electrical component.

19. The connection device of claim 6, wherein the shielded electrical cable comprises a coaxial cable having one signal wire connecting to a respective first connecting element and an outer conductive shield connected to a ground wire, the ground wire connecting to the grounding structure.

20. The connection device of claim 5, wherein the shielded electrical cable comprises one of a plurality of shielded electrical cables, the plurality of shielded electrical cables being disposed in the passage of the package housing, each cable having one or more signal wires connecting to respective first connecting elements, the first connecting elements being electrically connected to the respective second connecting elements, wherein the second connecting elements associated with each respective shielded electrical cable are provided in a respective isolated area, the second connecting elements associated with one shielded electrical cable being isolated from the second connecting elements associated with another shielded electrical cable.
